(19) United States
(12) Patent Application Publication
(10) Pub. No.: US 2019/0349277 A1
(43) Pub. Date: Nov. 14, 2019

(54) INFORMATION ELEMENT TO INDICATE LOSS OF BACKHAUL CONNECTION

(71) Applicant: LANDIS+GYR INNOVATIONS, INC., Alpharetta, GA (US)

(72) Inventors: Christopher Scott Hett, Smyrna, GA (US); Lawrence Harris, Duluth, GA (US); Vivek Bhatt, Cumming, GA (US); Craig Cornwall, Atlanta, GA (US); James Patrick Hanley, Decatur, GA (US)

(21) Appl. No.: 15/974,541

(22) Filed: May 8, 2018

(51) Int. Cl. H04L 12/26

(52) U.S. Cl. CPC H04L 43/0817; H04L 12/66; H04L 43/0829; H04L 43/0811

(57) ABSTRACT

Systems and methods for managing nodes in mesh networks are provided. An information element may be provided to indicate a status of a backhaul connection. A critical node may use the information element to determine the status of the backhaul connection prior to joining a PAN. A critical path may be created and maintained that includes the critical node and any intervening nodes between the critical node and the root. A critical node may switch PANs when a backhaul connection becomes unavailable. The switch may be facilitated by a node on the critical path other than the critical node. The loss of backhaul connection may be determined by examining the information element. A node may switch PANs and coordinate the switch with its child nodes.

### CROSS-REFERENCE TO RELATED APPLICATIONS

This application is related to U.S. Ser. No. ______ (Attorney Docket No. 035361/1058345) and U.S. Ser. No. ______ (Attorney Docket No. 035361/1061214), both of which are filed concurrently herewith and are incorporated herein by reference for all purposes.

### FIELD OF THE INVENTION

This invention relates to managing nodes in mesh networks, and in particular to providing an information element to indicate a loss of backhaul connection.

### BACKGROUND

A PAN architecture may have a hysteresis in network topology to prevent thrashing when there is a temporary disruption in the network, such as a temporary loss of backhaul connection. However, some systems and devices cannot tolerate a temporary loss of backhaul connection and need to switch PANs once the backhaul connection becomes unavailable.

Generally, a root node does not routinely communicate the status of the backhaul connection to the other nodes in the PAN. Instead, each node has to determine the state of the backhaul connection by sending upper layer messages and receiving a response from the backhaul. Since a node cannot send an upper layer message until it joins a PAN, a node cannot determine the status of the backhaul connection prior to joining. A node that requires a backhaul connection may join a PAN and then determine that a backhaul connection is unavailable.

A node that determines that the backhaul connection for its current PAN is unavailable, may determine that it needs to switch PANs. However, the node may not have direct visibility to another PAN, which may delay the switch to a different PAN.

When a node switches PANs, any child nodes remain with the current PAN by finding a new parent node or switch to the new PAN by unjoining the current PAN and joining the new PAN. This process is time consuming and causes the child node to be unavailable until it locates a new parent or completes the unjoining/joining process.

### SUMMARY

Aspects of the invention provide improvements to the way that a node determines the status of a backhaul connection and joins or switches to a PAN with an available backhaul connection. Additional aspects of the invention provide a more efficient way to switch PANs when a node has a child node. The node may bring its child node with it when it switches regardless of the reason for the switch.

A node may consider the status of a backhaul connection prior to joining a PAN. The node may be a critical node that requires an available backhaul connection. The status of the backhaul connection may be included in a layer 2 message, such as a beacon. In one example, backhaul status information is included in an information element in the beacon.

Once a critical node joins a PAN, a critical path may be established from the critical node to the root of the PAN. In one example, layer 3 messages, such as DAO messages are used to establish the critical path. Nodes along the critical path may seek to join a new PAN when the backhaul connection for the current PAN becomes unavailable.

When a node switches to a new PAN, it may coordinate the switch with its child nodes. The switching node identifies a new PAN and obtains timing synchronization information for the new PAN. The switching node sends timing synchronization information for the new PAN and a time for switching to the new PAN to its child nodes. The switching node and the child nodes maintain timing synchronization information for both the current PAN and the new PAN. At the time for switching, the switching node and its child nodes switch to the new PAN. A node may coordinate the switch to the new PAN with its child node whenever a switch occurs. The coordination is not limited to a switch based on a loss of a backhaul connection.

These illustrative aspects and features are mentioned not to limit or define the invention, but to provide examples to aid understanding of the inventive concepts disclosed in this application. Other aspects, advantages, and feature of the present invention will become apparent after review of the entire application.

### BRIEF DESCRIPTION OF THE DRAWINGS

These and other features, aspects, and advantages of the present disclosure are better understood when the following Detailed Description is read with reference to the accompanying drawings, where:

FIG. 1 illustrates two PANs and an unjoined critical node according to one aspect of the invention.

FIG. 2 illustrates a critical node joined to a PAN according to one aspect of the invention.

FIG. 3 illustrates a loss of a backhaul connection for a PAN according to one aspect of the invention.

FIG. 4 illustrates a critical node switching to a different PAN according to one aspect of the invention.

FIG. 5 illustrates a parent node switching to a different PAN according to one aspect of the invention.

FIG. 6 illustrates a parent node and its child nodes switching to a different PAN according to one aspect of the invention.

FIG. 7 illustrates communications between a joining node and two PANs according to one aspect of the invention.

FIG. 8 illustrates an exemplary node according to one aspect of the invention.

### DETAILED DESCRIPTION

The present invention is directed to systems and methods for managing nodes in mesh networks, including joining a critical node to a PAN, creating and maintaining a critical path, PAN switching by critical path nodes, and maintaining parent/child relationships when switching PANs. A critical node may consider the status of the backhaul connection for a PAN prior to joining the PAN. Once joined, a critical path from the critical node to the root is identified and nodes along the critical path, including the critical node, may attempt to join a new PAN if the backhaul connection for the current PAN becomes unavailable. The status of the backhaul connection for a PAN may be communicated in an information element (IE) in a beacon. If a critical path node is a parent node with one or more child nodes and it switches PANs, then the critical path node and the child nodes may switch PANs while maintaining their parent-child relationship. A parent node may maintain its parent-child relationship with its child node when it switches PANs for reasons other than a loss of a backhaul connection.

### Critical Node and Critical Path

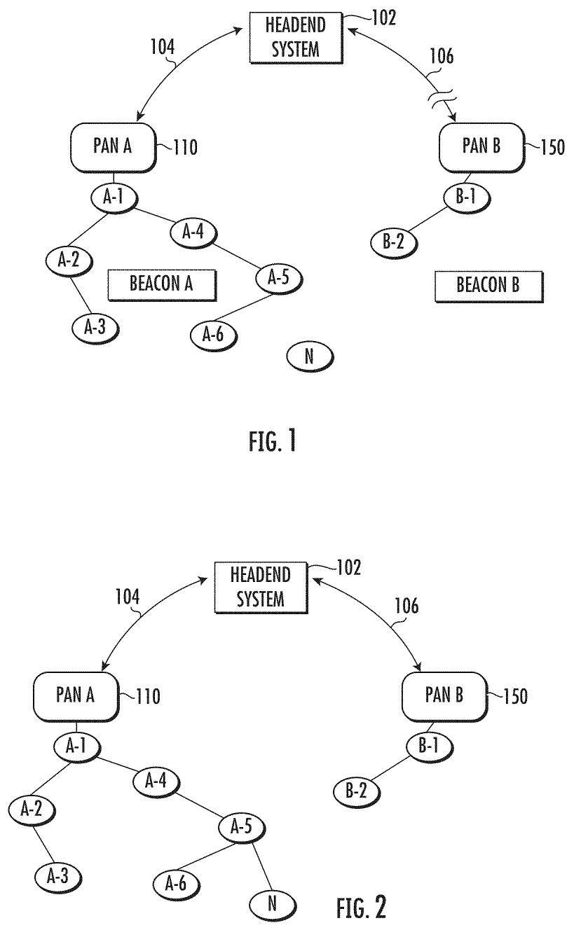

FIG. 1 illustrates two PANs, PAN A and PAN B. Node 110 is the root for PAN A and node 150 is the root for PAN B. PAN A includes nodes A-1 through A-6 and PAN B includes nodes B-1 and B-2. Backhaul connection 104 connects PAN A with a central system 102 and backhaul connection 106 connects PAN B with the central system. Although not shown in FIG. 1, there may be any number of intervening devices between a PAN and the central system 102.

Node 110 and node 150 monitor the status of their respective backhaul connections and include information about the status of their backhaul connections in their beacons. In one example, they determine whether they are connected to an NTP server and if so, determine that their backhaul connection is available. Other implementations may consider other factors to determine whether their backhaul connection is available or unavailable including, but not limited to, connection to a specific system or server or connection to a time source. Each node includes its current backhaul status information in an IE in its respective beacon. The IE may be a new IE or may be an existing IE. If an existing IE is used, then the backhaul status information may be appended to the IE. Any type of IE that includes backhaul status information is referred to herein as a backhaul status IE. The backhaul status information may be conveyed in one bit where a first value indicates that the backhaul connection is available and a second value indicates that the backhaul connection is unavailable or unknown. In some implementations, the backhaul status information includes additional information, such as how long the backhaul connection has been in its current state. For example, a timestamp indicating the time of the last status change may be used. In the example illustrated in FIG. 1, the backhaul connection 104 is available and the backhaul connection 106 is unavailable.

In FIG. 1, node N is a critical node that is not joined to either PAN. A critical node is a node that requires a backhaul connection. It may not be able to wait for the backhaul connection to reconnect if it becomes available. One example of a critical node is a node associated with DA (Distribution Automation) equipment, such as line sensors, switches, and re-closers. A node may be designated as a critical node upon installation or may be designated as a critical node after installation.

Node N receives Beacon A from PAN A and Beacon B from PAN B. In this example, Beacon A includes a backhaul status IE that indicates that backhaul connection 104 is available and Beacon B includes a backhaul status IE that indicates that backhaul connection 106 is unavailable. Since node N is a critical node, it joins PAN A. Critical nodes may be configured to avoid joining a PAN with an unavailable backhaul connection, even though other factors, e.g., rank, load, etc. may be favorable to joining the PAN.

FIG. 2 illustrates PAN A after node N joins. After node N joins, it sends a DAO message that identifies node N as a critical node. In one example, node N sets a bit in the DAO flag field to indicate that it is a critical node. Based on the DAO message, node 110, which is the root for PAN A, determines a critical path for node N and stores information describing the critical path for node N, i.e., the path including node N, node A-5, node A-4, and node A-1. The root may send a DAO-ACK message to Node N with a bit set to indicate that a critical path is in place.

In some implementations, as each node between the root and Node N receives the DAO-ACK message, the node checks the bit and determines that it is a critical path node. If a node does not support critical path nodes, then after it receives the message, it does not forward the message. Instead, it may discard the message or send an error message.

Node N may use other types of messages or other fields to indicate that it is a critical node including, but not limited to an indication in a hop-by-hop extension header of an IPv6 message. In one example, Node N sets a bit in a hop-by-hop extension header to indicate that it is a critical node and is requesting a critical path. When node A-5 supports critical path nodes, it receives the message, checks the bit, enters a pre-critical path state, and forwards the message to the next node. This process repeats until the message reaches the root of PAN A. When the root sends a message back to Node N indicating that a critical path is in place, the nodes between the root and Node N may examine the message and transition from a pre-critical path state to a critical path state.

Since PAN A may be a wireless mesh network, the critical path for node N may change. If the critical path changes, then the critical path for node N may include additional or different nodes. The critical path information maintained by the root and the critical path status of each node affected by the change are updated to reflect the change in the critical path.

After node N joins PAN A, it generates and sends beacons that include a backhaul status IE. Node N obtains the information for the backhaul status IE from the beacons that it receives from its parent node A-5 or other nodes in PAN A.

### Loss of Backhaul Connection and Critical Path

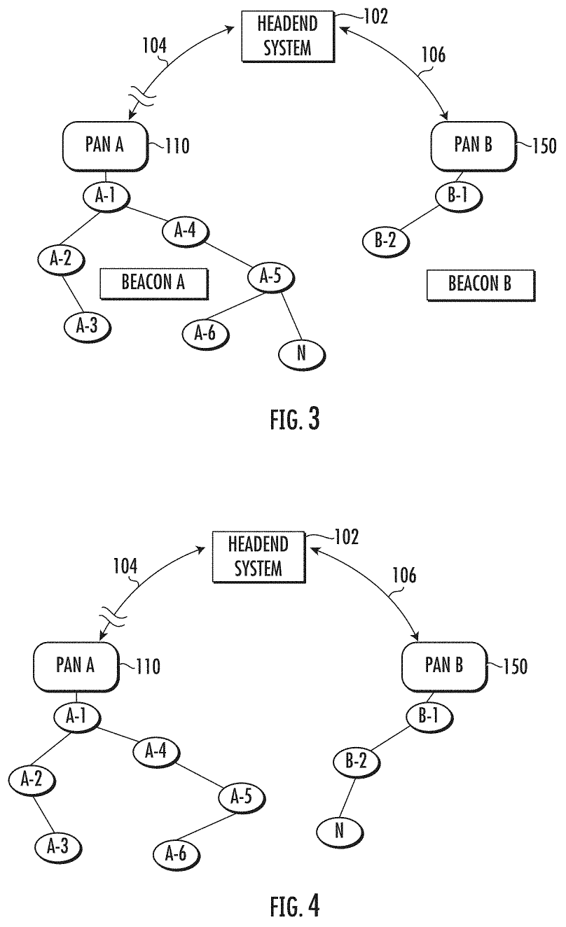

FIG. 3 illustrates the scenario where PAN A's backhaul connection becomes unavailable and PAN B's backhaul connection is available. When node 110 detects that its backhaul connection is unavailable, then it may generate a beacon, Beacon A, that includes backhaul status information in the backhaul status IE. The information regarding the status of the backhaul connection is propagated through the network until node N receives a beacon with a backhaul status IE indicating that the backhaul connection for PAN A is unavailable. Since node N is a critical node, it may begin searching for a new PAN to join once it determines that the backhaul connection for its current PAN is unavailable. If node N receives a beacon from a different PAN, such as Beacon B from PAN B, it may consider whether the backhaul connection for PAN B is available when determining whether to switch PANs. If it decides to switch PANs, then it may follow a similar process to that described above in connection with FIGS. 1 and 2 for joining PAN B. In this instance, the other nodes joined to PAN A may remain joined to PAN A, as shown in FIG. 4.

When node N joins PAN B, its parent node, node A-5 determines that node N is no longer a child node. In one example, node N sends a disassociation message to node A-5 prior to joining PAN B to inform node A-5 of the switch. Node N determines whether it has any other child nodes that are critical nodes or critical path nodes. If it does not have any other child nodes that are critical nodes or critical path nodes, then it determines that it is no longer on a critical path and sends a DAO message indicating that it is no longer a critical path node. Similarly, if node A-4 has no child nodes that are critical nodes or critical path nodes, then it sends a DAO message indicating that is it no longer a critical path node. If node A-1 has no child nodes that are critical nodes or critical path nodes, then it sends a DAO message to its parent node, node 110, and node 110 removes the critical path for node N. Node A-5 may remain a critical path node if it has another child node, e.g. Node A-6, that is a critical node or critical path node. In this situation, node 110 stores critical path information for Node A-6. Once a node, e.g. node A-5, is no longer a critical path node, then it may remain joined to its current PAN or switch to a target PAN based on factors other than the status of the backhaul connection for its current PAN and a target PAN.

In some instances, a critical node may only rarely receive a beacon from another PAN. Once a node on the critical path receives a beacon from another PAN with an available backhaul connection while the backhaul connection for the current PAN is unavailable, it may switch PANs. For example, if node A-5 receives a beacon from node A-4 or another node in PAN A with a backhaul status IE indicating that the backhaul connection for PAN A is unavailable, then node A-5 may search for a different PAN to join. Since node A-5 is on a critical path, it may be more aggressive in seeking a different PAN than if it weren't on a critical path. In some implementations, the node considers its RPL layer in determining how aggressively to seek a different PAN. For example, a layer 1 node may be less aggressive than a lower layer node.

If node A-5 receives a beacon from a different PAN, such as Beacon B from PAN B, it may determine whether to switch PANs based on whether the backhaul connection for PAN B is available. When the backhaul connection for PAN B is available, node A-5 joins PAN B, as shown in FIG. 5. FIG. 5 illustrates that after node A-5 joins PAN B, its child nodes, node A-6 and node N may not be joined to either PAN A or PAN B. Since node A-5 is not a critical node and does not have a child node that is a critical node in FIG. 5, it does not identify itself as a critical node or a critical path node after joining PAN B. In some implementations, node A-6 and node N each execute a separate joining process. Each node may rejoin PAN A by finding a new parent node, join PAN B through node A-5 (its PAN A parent node), or join PAN B by finding a different parent node. Since node N is a critical node and the backhaul connection for PAN A is unavailable, node N joins PAN B. In the scenario where node N joins PAN B as a child node of node A-5, node N sends a DAO message that identifies node N as a critical node. A critical path is established in a manner similar to that discussed above in connection with FIG. 2.

In some implementations, a secondary backhaul connection, such as Ethernet or cellular, may be available. If so, when a critical path node receives a beacon with a backhaul status IE indicating that the backhaul connection is unavailable, then the node may choose to remain on the current PAN and use the secondary backhaul connection.

If the backhaul status IE indicates that the backhaul connection is unavailable and includes information about how long the backhaul connection has been unavailable, then a critical path node may consider how long the backhaul connection has been unavailable when determining when to switch to a new PAN.

Although the foregoing examples discuss the use of the backhaul status IE in connection with critical nodes, the backhaul status IE may be used whenever backhaul status information is useful. It is not limited to use by critical path nodes.

Maintaining Parent-Child Relationship when Switching PANs

A node may maintain existing parent-child relationships when it switches to a new PAN. The switch may occur because a backhaul connection is lost or for any other reason.

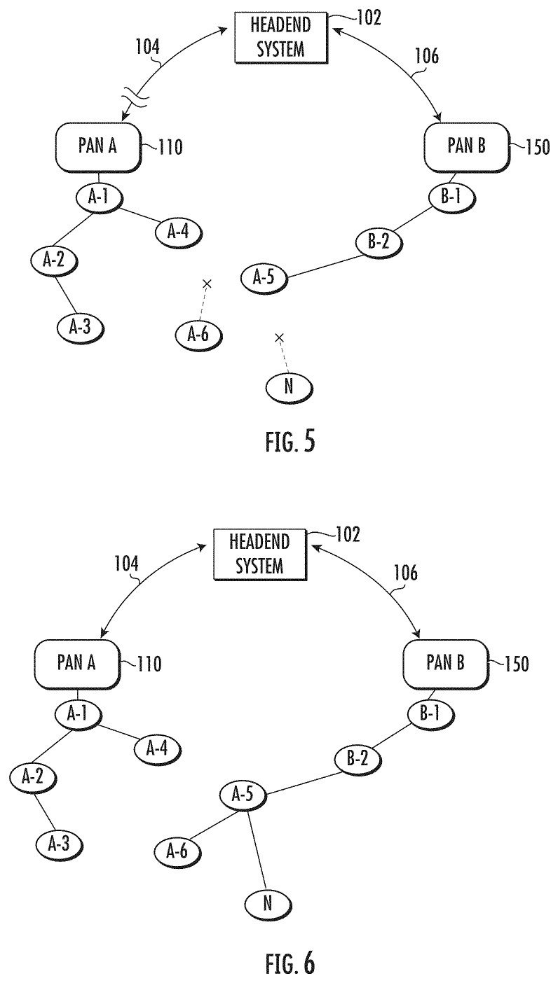

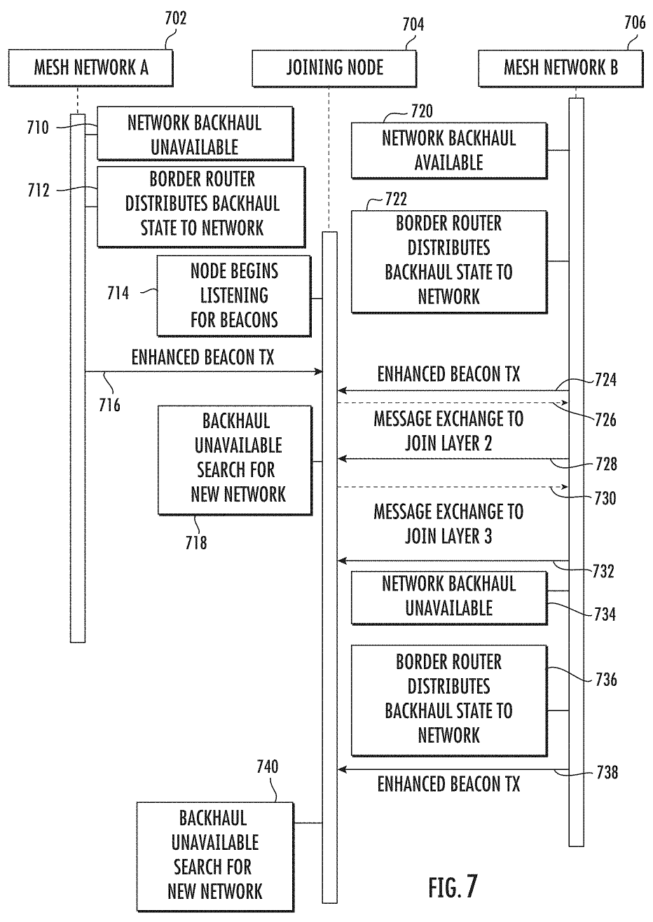

Continuing with the example of FIG. 3, node A-5 may bring its child nodes with it when it joins PAN B. Once node A-5 determines that it is going to switch to a target PAN, then the node maintains timing synchronization information for both its current PAN, e.g. PAN A, and its target PAN, e.g., PAN B. Node A-5 obtains the timing synchronization information for the target PAN from a beacon in the target PAN. Node A-5 communicates the timing synchronization information for the target PAN to its child nodes node A-6 and node N, as well as a time when it plans to switch to the target PAN. The timing synchronization information and the switch time may be communicated in a beacon from node A-5. For example, IEs in the beacon currently provide information about the network and include absolute slot number, channel hopping sequence, and timeslot offset information. An IE in the beacon may be modified to include a PAN switching timestamp. Only nodes that recognize node A-5 as their parent node may act upon the timing synchronization information and the switch time. Once nodes A-6 and node N receive the beacon with the timing synchronization information and the switch time, the nodes maintain timing synchronization information for both PAN A and PAN B. At the switch time, node A-5 and its child nodes, node A-6 and node N, switch from PAN A, as shown in FIG. 3, to PAN B, as shown in FIG. 6. After the switch, node A-5 may send a DIS message to node B-2 to trigger a DIO message from node B-2. In response to the DIO message, node A-5 may send a DAO message that indicates that its child node, node N, is a critical node and that node A-5 is on a critical path. Once node A-5 receives a DAO-ACK message, it may send a DIO message to its child nodes that it brought from PAN A, e.g., node A-6 and node N, via a unicast, multicast, or broadcast method so that the child nodes may obtain a new network prefix.

After the nodes switch to PAN B, the critical path includes node A-5, node B-2, node B-1, and node 150. By switching node A-5, node A-6, and node N to the target PAN together, the timing and network connectivity are maintained and the availability of the child nodes, e.g., node A-6 and node N, is improved.

The parent-child relationship between nodes may be maintained when the parent node determines that it is switching to a target PAN for any reason. It is not limited to the situation where the parent node is a critical path node or when the switch is based on a backhaul connection status.

Communications between Critical Node and PAN

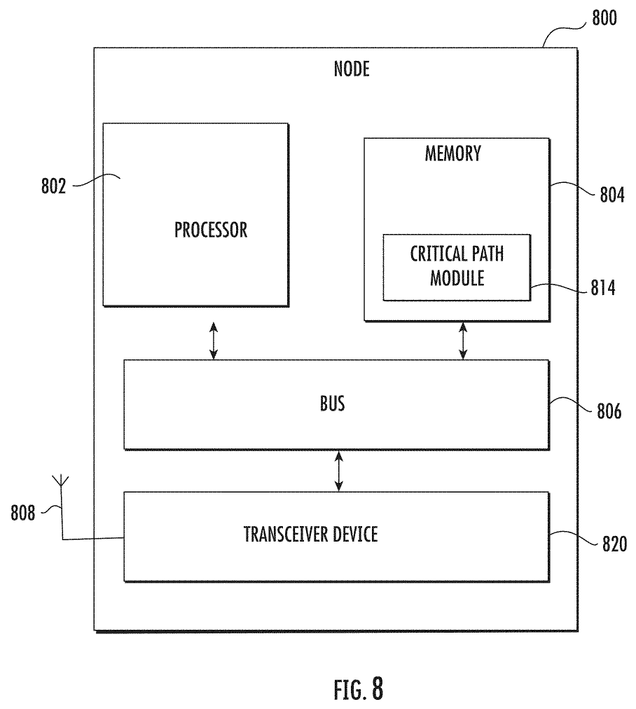

FIG. 7 illustrates a critical node 704 seeking to join a PAN. The node 704 initially determines whether to join a PAN corresponding to mesh network 702. At 710, the backhaul connection for network 702 becomes unavailable. Subsequently at 712, the border router or root node for network 702 communicates the loss of backhaul connection to the network. In one example, the border router sends a beacon with a backhaul status IE indicating that the backhaul connection is unavailable. Critical node 704 begins listening for beacons at 714 to find a network to join. At 716, node 704 receives a beacon from network 702. The beacon includes a backhaul status IE indicating that network 702 has lost its backhaul connection. Since node 704 is a critical node, it continues to listen for additional beacons to find a network with an available backhaul connection.

At 720, the backhaul connection for a PAN corresponding to mesh network 706 is available. At 722, the border router for network 706 communicates the availability of the backhaul connection to the network. In one example, the border router sends a beacon with a backhaul status IE indicating that the backhaul connection is available. At 724, node 704 receives a beacon from network 706. Since the beacon from network 706 indicates that the backhaul connection is available, node 704 determines that it will try to join network 706. Node 704 and network 706 conduct a message exchange 726, 728 at layer 2. The message exchange may include an association request and an association response message. Other types of message exchanges are also possible. Once joined at layer 2, node 704 and network 706 conduct another message exchange at layer 3. For example, node 704 may send a DAO message indicating that it is a critical node and a node within network 706 may respond with a DAO-ACK message.

At 734, the backhaul connection for network 706 becomes unavailable. Subsequently at 736, the border router for network 706 communicates the loss of backhaul connection to the network. At 738, a beacon from network 706 indicates that the backhaul connection for network 706 is unavailable. In response to receiving the beacon, node 704 begins searching for a new PAN at 740.

Although FIG. 7 uses a beacon to communicate backhaul status information, other implementations may use a different type of message including, but not limited to, another type of layer 2 message or a propriety frame.

### Exemplary Node

FIG. 8 illustrates an exemplary node 800. The node may include a processor 802, memory 804, and a transceiver device 820 each communicatively coupled via a bus 806. The components of node 800 can be powered by an A/C power supply or a low energy source, such as a battery (not shown). The transceiver device 820 can include (or be communicatively coupled to) an antenna 808 for communicating with other nodes. In some examples, the transceiver device is a radio-frequency (“RF”) transceiver for wirelessly transmitting and receiving signals.

The processor may include a microprocessor, an application-specific integrated circuit (“ASIC”), a state machine, a field programmable gate array (“FPGA”) or other suitable computing device. The processor can include any number of computing devices and can be communicatively coupled to a computer-readable media, such as memory 804. The processor can execute computer-executable program instructions or access information stored in memory to perform operations, such as those described herein. The instructions may comprise processor-specific instructions generated by a compiler and/or an interpreter from code written in any suitable computer-programming language. When instructions, such as those provided in a critical path module 814, are executed, they may configure the node to perform any of the operations described herein. Although the processor, memory, bus, and transceiver device are depicted in FIG. 8 as separate components in communication with one another, other implementations are possible. The systems and components discussed herein are not limited to any particular hardware architecture or configuration.

While the present subject matter has been described in detail with respect to specific aspects thereof, it will be appreciated that those skilled in the art, upon attaining an understanding of the foregoing, may readily produce alterations to, variations of, and equivalents to such aspects. Accordingly, it should be understood that the present disclosure has been presented for purposes of example rather than limitation, and does not preclude inclusion of such modification, variations, and/or additions to the present subject matter as would be readily apparent to one of ordinary skill in the art.

What is claimed is:

1. A node joined to a network, comprising:
a processing device;
a network interface capable of communicating on the network; and
a memory configured by a critical path module,
wherein execution of the critical path module configures the node to:
receive a layer 3 message from a second node that identifies a critical path, wherein the critical path includes a critical node and at least the second node;
determine a status of a backhaul connection between a first PAN and a central system;
generate a first layer 2 message with a backhaul status information element (IE) indicating that the backhaul connection is unavailable when the backhaul connection is unavailable;
transmit the first layer 2 message;
determine an updated status of the backhaul connection between the first PAN and the central system;
generate a second layer 2 message with a backhaul status IE indicating that the backhaul connection is available when the backhaul connection is available; and
transmit the second layer 2 message.

2. The node of claim 1, wherein execution of the critical path module, further configures the node to determine the status of the backhaul connection between the first PAN and the central system by evaluating a backhaul status IE from a received layer 2 message.

3. The node of claim 2, wherein execution of the critical path module, further configures the node to:
when the backhaul status IE from the received layer 2 message indicates that the backhaul connection is unavailable, searching for another PAN.

4. The node of claim 1, wherein execution of the critical path module, further configures the node to determine the status of the backhaul connection between the first PAN and the central system by determining whether the node is connected to a time source.

5. The node of claim 1, wherein execution of the critical path module, further configures the node to after transmitting the first layer 2 message, receiving a second layer 3 message from the second node, wherein the second layer 3 message indicates that the second node is no longer on the critical path.

6. The node of claim 1, wherein the first layer 3 message is a DAO message and the first layer 2 message is a beacon.

7. A method executed by a node, comprising:
receiving a layer 3 message from a second node that identifies a critical path, wherein the critical path includes a critical node and at least the second node;
determining a status of a backhaul connection between a first PAN and a central system;
generating a first beacon with a backhaul status information element (IE) indicating that the backhaul connection is unavailable when the backhaul connection is unavailable;
transmitting the first beacon;
determining an updated status of the backhaul connection between the first PAN and the central system;
generating a second beacon with a backhaul status IE indicating that the backhaul connection is available when the backhaul connection is available; and
transmitting the second beacon.

8. The method of claim 7, wherein determining a status of a backhaul connection between a first PAN and a central system comprises evaluating a backhaul status IE from a received beacon for the first PAN.

9. The method of claim 8, further comprising:
when the backhaul status IE from the received beacon for the first PAN indicates that the backhaul connection is unavailable, searching for another PAN.

10. The method of claim 7, wherein determining a status of a backhaul connection between a first PAN and a central system comprises determining whether the node is connected to an NTP server.

11. The method of claim 7, further comprising:
after transmitting the first beacon, receiving a second layer 3 message from the second node, wherein the second layer 3 message indicates that the second node is no longer on the critical path.

12. The method of claim 7, wherein the first layer 3 message is a DAO message.

13. A method to join a node to a network, comprising:
receiving a first beacon, wherein the first beacon includes a backhaul status information element (IE) indicating a status of a backhaul connection associated with a first PAN;
analyzing the backhaul status IE in the first beacon to determine whether the backhaul connection associated with the first PAN is available;
when the backhaul status IE in the first beacon indicates that the backhaul connection associated with the first PAN is unavailable, continuing to listen for additional beacons;
receiving a second beacon, wherein the second beacon includes a backhaul status IE indicating a status of a backhaul connection associated with a second PAN;
analyzing the backhaul status IE in the second beacon to determine whether the backhaul connection associated with the second PAN is available; and
when the backhaul status IE in the second beacon indicates that the backhaul connection associated with the second PAN is available, joining the second PAN.

14. The method of claim 13, further comprising:
after joining the second PAN, receiving a third beacon, wherein the third beacon includes a backhaul status IE indicating a status of the backhaul connection associated with the second PAN;
generating a fourth beacon that includes a backhaul status IE indicating the status of the backhaul connection associated with the second PAN; and
transmitting the fourth beacon.

15. The method of claim 14, further comprising:
when the backhaul status IE in the third beacon indicates that the backhaul connection for the second PAN is unavailable, then evaluating a beacon received from a different PAN to determine whether a backhaul connection associated with the different PAN is available.

16. The method of claim 13, further comprising:
after joining the second PAN, transmitting a layer 3 message to a parent node indicating that the node is a critical node that requires a backhaul connection.

17. The method of claim 16, further comprising:
receiving, by the parent node, the layer 3 message; and
identifying the parent node as a critical path node.
